(19) United States
(12) Patent Application Publication
(10) Pub. No.: US 2004/0021061 A1
(43) Pub. Date: Feb. 5, 2004

(54) Photodiode, charged-coupled device and method for the production

(76) Inventor: Frederik Bijkerk, Amsterdam (NL)

Correspondence Address: HUDAK, SHUNK & FARINE, CO., L.P.A., 2020 FRONT STREET, SUITE 307, CUYAHOGA FALLS, OH, 44221, US

(21) Appl. No.: 10/208,464

(22) Filed: Jul. 30, 2002

(51) Int. Cl. H01J 40/14

(52) U.S. Cl. 250/214 R

(57) ABSTRACT

Photodiodes and charged-coupled devices show a drop in measuring sensitivity under prolonged exposure to radiation. This is due to oxidation and/or contamination of the active surface of the photodiodes or the charged-coupled devices.

The invention discloses photodiodes and charged-coupled devices with at least one protective layer that consists of one material of the group consisting of carbides, oxides, borides, nitrides, fluorides, boron, carbon, tetrafluorethylen, ruthenium, rhenium, palladium, gold, platinum.

The invention further discloses methods for the production of such photodiodes and charged-coupled devices and different ways of using such photodiodes.

### DESCRIPTION

The invention relates to a photodiode as well as a charged-coupled device for applications in the visible, the vacuum ultraviolet (VUV), the extreme ultraviolet (EUV) and/or the soft x-ray spectral range having a protective coating. Further, the invention relates to production methods for a photodiode or a charged-coupled device. Furthermore, the invention relates to different applications of the photodiode.

Silicon p-n junction photodiodes, e.g. AXUV-diodes® (trade mark of International Radiation Detectors, Inc. (IRD), Torrance, Calif.) have been developed for applications in the visible, the VUV, the EUV and the soft x-ray spectral range (wavelength range 1000-0,1 mm).

When these diodes are exposed to photons of energy greater than 1.12 eV (wavelength less than 1100 nm), electron-hole pairs (charge carriers) are created. These photogenerated carriers are separated by the p-n junction electric field and a current proportional to the number of electron-hole pairs created flows through an external circuit.

These diodes usually have an extremely thin (3 to 12 nm), radiation-hard, silicon dioxide passivated top layer.

The radiation hardness of AXUV diodes is 100 to 1000 Mrads when tested with 10 eV photons. This hardness is greater than that of commonly available PIN silicon diodes.

Diodes with 1 Gigarad hardness are fabricated by nitrogen doping at the Si—SiO₂ interface to form an oxynitride top layer instead of the standard silicon dioxide top layer.

Charged-coupled devices (CCD) are similar to photodiodes concerning the principle of converting light into current and can be considered as being a two-dimensional array of photodiodes. They are mostly used in CCD cameras.

“High-accuracy detector calibration for EUV metrology at PTB”, by Frank Scholze et al. SPIE-Conference, 27^{th} Annual International Symposium on Microlithography, Santa Clara, Calif., U.S.A., February 2002, reports on the degradation of EUV photodiodes, more specifically on AXUV diodes which are coated with a passivation layer of nitrogen doped SiO₂ or TiSi₂. The reader is informed that the degradation of these and other hardened photodiodes could nevertheless be detected using a cryocooled radiometer as calibration standard. The spectral sensitivity of an AXUV photodiode was measured in 1995 and in 1997. Between these measurements the diode was stored in dry air and used only occasionaly in ultra high vacuum at moderate radiation levels (<1 μW/cm²). No noticable changes in sensitivity were measured. Between 1997 and 2001, the photodiode was extensively exposed to EUV radiation and a clear drop in sensitivity was measured. From the spectral characteristic of this measurement, it could be derived that the cause of the drop is oxidation of the active surface of the photodiode. The consequence of such a degradation is that the sensitivity of the photodiode, by which the dependence of the measured photocurrent upon the irradiated EUV radiation power is meant, decreases with time.

It has heretofore been assumed that EUV photodiodes will measure the output of EUV sources in EUV lithography apparatus with high long-term stability, which actually is not the case. Scholze et al. demonstrate that measurement accuracy can decrease with time, which has detrimental effects on the quality of EUV projection in the lithography tool. More specifically, the dose control of the illumination reduces significantly. As a result thereof, the control of the critical dimensions of the semiconductor circuit reduces.

The standard passivation layers used, like e.g., SiO₂ or TiSi₂, could not prevent degradation of the photodiodes, though.

It is the object of the invention to protect photodiodes as well as CCD in such a manner that no degradation takes place over long periods of time or under prolonged exposure to radiation.

The solution to this object is to provide photodiodes as well as CCD with at least one protective layer that consists of one material of the group consisting of carbides, oxides, borides, nitrides, fluorides, boron, carbon, tetrafluorethylen, ruthenium, rhenium, palladium, gold, platinum.

Further solutions consist of photodiodes as well as CCD having one or two protective layers that consist of one material of the group consisting of carbides, oxides, borides, nitrides, fluorides, boron, carbon, tetrafluorethylen, ruthenium, rhenium, palladium, gold, platinum.

The carbides may include silicon carbide, boron carbide and molybdenum carbide. The oxides may include molybdenum oxide, berylium oxide, silicon oxide, titanium dioxide and aluminium oxide. The boride may be molybdenum boride. The nitrides may include silicon nitride, boron nitride and titanium nitride. The fluorides may include magnesium fluoride and lithium fluoride.

Protective layers of this type are described in EP 1150139 A2 for multilayer systems of optical components. It was however found that these protective layers are also suited for use with photodiodes though the structure of the photodiodes is different from that of multilayer systems. Most photodiodes as well as CCD have a thin layer of n-doped silicium that is deposited onto a thicker, p-doped epitaxial layer. Whereas with multilayered coatings, what matters is that the properties of reflectivity of the protective layer are not impaired or are even enhanced, the measuring sensitivity of photodiodes as well as CCD is not allowed to be affected by said protective layer. It is therefore important that the absorption properties of the protective layer or layers in the corresponding spectral range be low or negligible so that the irradiated power may be detected in its entirety. In contrast to the effects caused by oxidation on the surface of the photodiodes or the CCD, the protective layers proved not to impair the measuring sensitivity.

Though the use of protective layers may lead to a marginally reduced sensitivity of the photodiode or the CCD as compared to unprotected diodes or the CCD, this reduction is of no relevance to the application of the diode since, prior to normal usage, the diode sensitivity is calibrated in any case. So is the CCD sensitivity. It is the value of the use of a protective layer that its calibration is preserved, even under prolonged usage of the diode or CCD, allowing consistancy in the measurements over a prolonged period of time. The protective coating, which may consist of one or several protective layers, preferably is in the range of 0.1 nm to 10 nm, more specifically in the range of 1 nm to 3 nm

By applying a protective coating from at least one of the said materials a situation is achieved where the photodiode or CCD is not only passivated against radiation damage and chemical or mechanical influences, but also the measuring sensivity of the photodiode or CCD is not influenced. In contrast with conventional passivation layers on photodiodes or CCD the life span can be increased by a factor of at least 100.

The protective coating according to the invention has the advantage that it can be cleaned, without suffering any losses in measuring sensitivity. Here various options for cleaning methods may be employed, for example ozone cleaning or wet or dry chemical etching.

Moreover, the protective coating according to the invention shows the positive characteristic, compared with the photodiodes or CCD of the prior art, of increased insensitivity to the partial pressure of water and/or water containing components, which are to be found during use of the photodiode in a vacuum chamber. This results in the risk from oxidation by water being lessened.

The most important advantage of the protective coating according to the invention is an improved resistivity against oxidation and contamination. This is illustrated by the following materials chosen as examples without restricting the scope of protection:

Ruthenium is an inert material which is resistant to surface deterioration caused, for example, by oxidation. In optical applications it has hitherto been used as a layer with a small refractive index in multilayer systems.

Aluminium oxide, also known as an alumina, occurs in various modified forms. Aluminium oxide in the form of corundum is used on account of its hardness for example as bearing stones in clocks or electrical measuring instruments.

Titanium nitride serves as the main material for the production of hardening and anti-wear protective surface coatings on precision machine bearings, roller bearings, cutting tools and the like, for lining reaction containers, especially for liquid metals such as aluminium, copper and iron and for the coating of clock housings and jewellery. Thin coatings of titanium nitride can be created, for example, by gas phase precipitation.

Carbon is known to possess suitable properties as one of the materials in multilayer systems in the sense that it grows as an amorphous, dense layer with low chemical reactivity.

The coating materials according to the invention have not yet been used as protective coatings for photodiodes or CCD for the purpose of producing an improved resistance against oxidation or other degradation of the top surface layer.

In a prefered embodiment the outermost layer of the protective coating consists of ruthenium or carbon.

The method for the production of a photodiode or CCD is characterized in that the protective coating comprising at least one protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode or CCD and in that at least one layer is produced with ion beam support during its application.

An alternation method is characterized in that the protective coating comprising one protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode or CCD and in that the one layer is produced with ion beam support during its application.

A further method is characterized in that the protective coating comprising two protective layers that consist each of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode or CCD and in that at least one layer is produced with ion beam support during its application.

The ion beam support may be e.g ion beam assisted deposition (IBAD) or ion etching. Ion irradiation during thin film growth is an effective means of controlling the structure and the composition of the thin film.

The use of one or more inert gases for the ion beam has been proven especially successful. An ion beam containing argon, krypton, oxygen, carbon and/or nitrogen is preferred. In the latter case, the protective layer can be produced by first of all applying one of the enumerated metals and there forming a corresponding protective layer of the corresponding oxide or nitride through a deposit with input of oxygen or nitrogen from the ion beam.

In a preferred embodiment, to form the protective layer, carbon is introduced into e.g a silicon or molybdenum layer, or oxygen into e.g an aluminium or titanium layer, or nitrogen into e.g a titanium layer, wherein the layer is polished with a carbon-, oxygen- or nitrogen-containing ion beam. Methane ions can for example be used for a carbon-containing ion beam. Thus, carbon, oxygen or nitrogen are incorporated into the e.g silicon, molybdenum, titanium or aluminium layer, so that an interface made from e.g silicon carbide, aluminium oxide, molybdenum carbide, titanium dioxide or titanium nitride is formed.

Another preferred possible method for producing a photodiode or CCD with a protective layer of at least a carbide, an oxide or a nitride consists of applying a thin layer of the metal of atomic thickness. This material is oxidized or nitridized or carbonized by applying low-energy oxygen or nitrogen or carbon ions. The formation of these chemical compounds can take place during or just after the growth of the single material films. This method works best with silicon or a metal as first material.

The most important influence of the low energy ions, however, is an improvement of the environmentally protective properties of the layer, due to the layer densification and the improvement of the layer morphology. Further particulars on the treatment of the surface with ion beams are to be found, for example, in M. Cilia et al., J. Appl.-Phys. 82 (9), 1997, pp. 4137-4142 and in E. J. Puik et al., Appl. Surf. Sc. 47, pp. 251-260 (1991).

The thickness of the protective layer can equally be adjusted by the surface treatment by means of an ion beam.

In a preferred embodiment after deposition the protective carbon layer is exposed at least to EUV radiation, to electron beam, or to elevated temperatures. These additionally applied processes lead to enhanced stability of the protections layers.

The photodiodes are preferably used in an EUV-lithographic system or in systems for x-ray microscopy, x-ray fluorescence analysis or spectroscopy.

Concerning the use of a photodiode in an EUV lithography stepper, a curved Mo/Si multilayer mirror is used to collect the light from the EUV light source and directs the reflected beam on to the diode. Dose quantisation accuracy needs to be within 0.5%. Diode degradation due to carbon built up on the diode surface leads to a reduced exposure accuracy and a loss of the accuracy in the printing of the smallest features by the EUV stepper. The use of a photo diode with a top surface protected according to the invention, avoids degradation of the diode sensitivity and preserves the accuracy of the lithographic imaging.

As for the use in the long term monitoring of the photon flux of an EUV light source developed for EUV lithography, the diode is used to monitor the stability of the light source, with a pulse-pulse repeatability requirement of typically 3%, 3σ and a source with cleanliness allowing usage during at least 30000 hrs. During the monitoring however, the diode surface is gradually contaminated by a carbon layer due to EUV induced cracking of carbon hydrates present in the background gas in the source vacuum chamber. Also oxidation of the top surface takes place induced by residual water in the vacuum chamber. These effects lead to enhanced absorption of the radiation, typically with about 1% per nanometer of carbon (which may grow within several hours) or 0.5 to 1% per nanometer of oxide. The diode reading thus drops 1% per several hours and becomes unreliable. The contamination may be mitigated in full, by applying a special carbon protective layer on the diode, e.g by ion-assisted deposition on the diode surface. The thus prepared carbon layer forms a stable protective layer that avoids oxidation and contamination of the diode so that the diode reading remains stable over a prolonged duration of several months up to several years.

CCD cameras are essentialy two dimensional arrays of photodiodes. For the VUV, EUV and x-ray range, e.g. so-called back-illuminated or back-thinned CCD cameras are used. They have a specially prepared top layer to make them suitable for the said spectral ranges by reducing the absorption of standard CCD top layers. Due to the surface thinning, they get very sensitive for degradation and surface oxidation. By using protective layers according to the invention, the lifetime of the CCD cameras is considerably extended.

The advantages of the invention are made clear by the following examples.

In tables 1 to 5 are shown different photodiodes with protective coating for different usage. In table 1 are shown photodiodes for use in dose control in EUV steppers, in table 2 are shown photodiodes for long term monitoring of EUV light sources, in table 3 are shown photodiodes for use in visible VUV spectrometers, in table 4 are shown photodiodes for use in x-ray fluorescence analysis, in table 5 are shown photodiodes for the use in x-ray microscopes and in table 6 are shown protective layers on backthinned CCD camera.

The protective coating consisting of one, two or three layers have been tested with two types of diodes, one being a photodiode of the type of a silicon n-on-p junction diode, the other being an AXUV 100® photodiode fabricated by IRD, Inc. The CCD camera is based on silicon n-on-p junctions.

All photodiodes have been tested in their respective experimental environment, that is dose control in EUV steppers, long term monitoring of EUV light sources, VUV spectrometer, x-ray fluorescence analysis, x-ray microscope. So has the CCD camera. After 15 h of exposure, they still show a relative sensitivity of 0.98 to 0.99. The sensitivity drop occurs after 2 to 3 h. Then, the relative sensitivity stays constant. Even a cleaning treatment with EUV-radiation in oxygen atmosphere had no noticable effect. The reference detector was an electrical substitution radiometer.

For comparision, the unprotected photodiodes and the unprotected CCD camera showed a steady degradation of ca. 2% after 2 h and ca. 8% after 8 h.

The various photodiodes and the CCD camera have been coated by the following methods:

The photodiodes/the protection layer for the CCD camera according to examples A1, A8, B1 and F2 were vapour-deposited. With the help of an argon ion beam, the thickness was adjusted to 1.5 nm, 2.8 nm, 2.6 nm and 2.5 nm respectively.

For the production of photodiodes according to example B 12, first a silicon layer was grown. The silicon layer was mixed by a carbon ion beam to silicon carbon. After that, a boron ion beam was added to the carbon ion beam to grow the boron carbide layer. Then, the boron ion beam was switched off to grow the outmost carbon layer. The production of photodiodes according to examples C4 is similar: First, a boron layer was grown, then a carbon ion beam was switched on simultaneously to grow the boron carbide layer and, last, the boron source was switched off to grow the outmost carbon layer.

The protective coating of the photodiodes according to the examples A6, A10, A11 and D2 were produced in an atmosphere containing oxygen and smoothed with the help of krypton ion beam.

The photodiodes/the protection layers for the CCD camera according to the examples B6, B5, B12, E4, F3 and F7 were produced by, first, sputtering a monoatomic layer of the corresponding metal onto the active surface of the photodiodes. Then, the metalic layers were converted to the corresponding oxid by the application of low energy oxygen ions. Correspondingly, the photodiodes/the protective layer for the CCD camera according to the examples A4, B4, B9, C2 and F6 were produced by the application of low energy nitrogen ions and the photodiodes according to the examples A7, B7 and C3 were produced by the application of low energy fluoride ions. The photodiodes according to the example A5 were produced with the support of a nitrogen ion beam. The protective layers for the CCD camera according to the examples F4, F5 were produced with the support of a carbon beam.

The outermost ruthenium layers of the examples A9, A10, A11, B8, B9, D3, E1 and F1 were sputtered. So were the photodiodes according to the examples A5, B2, C1, D1 and E2. The desired thickness has been achieved by ion etching with an argon or a krypton ion beam. Ion etching has the further advantage to polish the respective layer surface.

The photodiodes according to the examples A2, A9, A12, B3, B10, B11, B12, B13, C2, C3, C4, D3, and E3 show an outermost carbon layer. This was deposited with ion beam support using argon, krypton and/or carbon ion beams. To further enhance the stability of the protective layers, the photodiodes according to B10 to 13 have been exposed to EUV radiation, the photodiodes according to examples C2 to 4 have been exposed to elevated heat and the photodiode according to the example A12 has been exposed to an electron beam.

TABLE 1
dose control in EUV stepper

| Ex. # | protective coating | thickness |
|---|---|---|
| A 1 | C | 1.5 nm |
| A 2 | Ru | 2.0 nm |
| A 3 | SiC | 1.3 nm |
| A 4 | Si₃N₄ | 1.6 nm |
| A 5 | TiN | 2.0 nm |
| A 6 | molybdenum boride | 0.9 nm |
| A 7 | TiO₂ | 2.7 nm |
| A 8 | LiF | 3.1 nm |
| A 9 | C₂F₄ | 2.8 nm |
| A 10 | molybdenum carbide | 0.8 nm/0.6 nm |
| A 11 | Al₂O₃/Ru | 0.8 nm/0.6 nm |
| A 12 | TiO₂/Ru | 0.9 nm/0.7 nm |
| A 13 | SiC/B₄C/C | 0.4 nm/0.4 nm/0.4 nm |

TABLE 2
long term monitoring of EUV light source

| ex. # | protective coating | thickness |
|---|---|---|
| B 1 | B | 2.6 nm |
| B 2 | Au | 1.8 nm |
| B 3 | Ru | 2.1 nm |
| B 4 | SiC | 2.0 nm |
| B 5 | B₄C | 2.4 nm |
| B 6 | BN | 2.1 nm |
| B 7 | molybdenum oxide | 2.3 nm |
| B 8 | Al₂O₃ | 3.0 nm |
| B 9 | MgF₂ | 2.9 nm |
| B 10 | C/Ru | 1.5 nm/0.6 nm |
| B 11 | TiN/Ru | 2.0 nm/0.5 nm |
| B 12 | SiC/C | 1.3 nm/0.4 nm |
| B 13 | B₄C/C | 0.8 nm/0.8 nm |
| B 14 | Al₂O₃/C | 1.2 nm/0.3 nm |
| B 15 | Rh/C | 1.0 nm/0.3 nm |

TABLE 3
VUV spectrometer

| Ex. # | protective coating | thickness |
|---|---|---|
| C 1 | Pd | 1.0 nm |
| C 2 | BN/C | 1.0 nm/0.5 nm |
| C 3 | LiF/C | 1.5 nm/0.4 nm |
| C 4 | B/B₄C/C | 0.5 nm/0.6 nm/0.5 nm |

TABLE 4
x-ray fluorescence analysis

| Ex. # | protective coating | thickness |
|---|---|---|
| D 1 | Rh | 2.5 nm |
| D 2 | beryllium oxide | 2.7 nm |
| D 3 | SiC/Ru | 1.0 nm/1.0 nm |

TABLE 5
x-ray microscope

| Ex. # | protective layer | thickness |
|---|---|---|
| E 1 | Ru | 1.8 nm |
| E 2 | Pt | 1.9 nm |
| E 3 | molybdenum carbide | 2.4 nm |
| E 4 | ruthenium oxide | 2.0 nm |

TABLE 6
back-thinned CCD camera

| Ex. # | protective layer | thickness |
|---|---|---|
| F 1 | Ru | 2.2 nm |
| F 2 | C | 2.5 nm |
| F 3 | Al₂O₃ | 1.8 nm |
| F 4 | SiC | 1.9 nm |
| F 5 | molybdenum carbide | 2.7 nm |
| F 6 | TiN | 2.4 nm |
| F 7 | TiO | 1.7 nm |

1. Photodiode for applications in the visible, the vacuum ultraviolet (VUV), the extreme ultraviolet (EUV) and/or the soft x-ray spectral range having a protective coating, characterized in that the protective coating comprises one or more protective layers that consists of one material of the group consisting of carbides, oxides, borides, nitrides, fluorides, boron, carbon, tetrafluorethylen, ruthenium, rhenium, palladium, gold, platinum.

2. Photodiode according to claim 1, characterized in that the protective coating comprises one protective layer that consists of one material of the group consisting of carbides, oxides, borides, nitrides, fluorides, boron, carbon, tetrafluorethylen, ruthenium, rhenium, palladium, gold, platinum.

3. Photodiode according to claim 1, characterized in that the protective coating comprises two protective layers that consist each of one material of the group consisting of carbides, oxides, borides, nitrides, fluorides, boron, carbon, tetrafluorethylen, ruthenium, rhenium, palladium, gold, platinum.

4. Charged-coupled device for applications in the visible, the vacuum ultraviolet (VUV), the extreme ultraviolet (EUV) and/or the soft x-ray spectral range having a protective coating, characterized in that the protective coating comprises one or more protective layers that consists of one material of the group consisting of carbides, oxides, borides, nitrides, fluorides, boron, carbon, tetrafluorethylen, ruthenium, rhenium, palladium, gold, platinum.

5. Charged-coupled device according to claim 4, characterized in that the protective coating comprises one protective layer that consists of one material of the group consisting of carbides, oxides, borides, nitrides, fluorides, boron, carbon, tetrafluorethylen, ruthenium, rhenium, palladium, gold, platinum.

6. Charged-coupled according to claim 4, characterized in that the protective coating comprises two protective layers that consists each of one material of the group consisting of carbides, oxides, borides, nitrides, fluorides, boron, carbon, tetrafluorethylen, ruthenium, rhenium, palladium, gold, platinum.

7. Photodiode or charged-coupled device according to claim 1 or 4, characterized in that the carbide is one of the group consisting of silicon carbide, boron carbide, molybdenum carbide.

8. Photodiode or charged-coupled device according to claim 1 or 4, characterized in that the oxide is one of the group consisting of molybdenum oxide, beryllium oxide, titanium dioxide, alumium oxide.

9. Photodiode or charged-coupled device according to claim 1 or 4, characterized in that the boride is molybdenum boride.

10. Photodiode or charged-coupled device according to claim 1 or 4, characterized in that the nitride is one of the group consisting of silicon nitride, boron nitride, titanium nitride.

11. Photodiode or charged-coupled device according to claim 1 or 4, characterized in that the fluoride is one of the group consisting of magnesium fluoride and lithium fluoride.

12. Photodiode or charged-coupled device according to claim 1 or 4, characterized in that the thickness of the protective coating is in the range of 0.1 nm to 10.0 nm.

13. Photodiode or charged-coupled device according to claim 1 or 4, characterized in that the thickness of the protective coating is in the range of 0.1 nm to 3.0 nm.

14. Photodiode or charged-coupled device according to claim 1 or 4, characterized in that the outermost layer consists of ruthenium or carbon.

15. Method for the production of photodiodes for applications in the visible, the vacuum ultraviolet (VUV), the extreme ultraviolet (EUV) and/or the soft x-ray spectral range having a protective coating, characterized in that the protective coating comprising one or more protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode and in that at least one layer is produced with ion beam support during its application.

16. Method for the production of photodiodes according to claim 15, characterized in that the protective coating comprising one protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode and in that the one layer is produced with ion beam support during its application.

17. Method for the production of photodiodes according to claim 15, characterized in that the protective coating comprising two protective layers that consist each of one material of the group consisting of carbides, oxides, borides, nitrides, fluorides, boron, carbon, tetrafluorethylen, ruthenium, rhenium, palladium, gold, platinum is supplied directly to the active surface of the unprotected photodiode and in that at least one layer is produced with ion beam support during its application.

18. Method for the production of charged-coupled devices for applications in the visible, the vacuum ultraviolet (VUV), the extreme ultraviolet (EUV) and/or the soft x-ray spectral range having a protective coating, characterized in that the protective coating comprising one or more protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected charged-coupled device and in that at least one layer is produced with ion beam support during its application.

19. Method for the production of charged-coupled devices according to claim 18, characterized in that the protective coating comprising one protective layer that consists of one material of the group consisting of carbides, oxides, borides, nitrides, fluorides, boron, carbon, tetrafluorethylen, ruthenium, rhenium, palladium, gold, platinum is supplied directly to the active surface of the unprotected charged-coupled device and in that the one layer is produced with ion beam support during its application.

20. Method for the production of charged-coupled devices according to claim 18, characterized in that the protective coating comprising two protective layers that consist of one material of the group consisting of carbides, oxides, borides, nitrides, fluorides, boron, carbon, tetrafluorethylen, ruthenium, rhenium, palladium, gold, platinum is supplied directly to the active surface of the unprotected charged-coupled device and in that at least one layer is produced with ion beam support during its application.

21. Method according to claim 15 or 18, characterized in that one or more inert gases are used for the ion beam.

22. Method according to claim 15 or 18, characterized in that an ion beam containing argon, krypton, carbon or nitrogen is used.

23. Method according to claim 15 or 18, characterized in that the protective coating consists of at least one carbon layer deposited with ion beam support.

24. Method according to claim 23, characterized in that after deposition the protective carbon layer is exposed at least to EUV radiation, to electron beam, or to elevated temperatures.

25. Method according to claim 15 or 18 characterized in that the protection layer material is deposited of atomic thickness and then is converted to a state of oxide or nitride or carbide by applying low-energy oxygen or nitrogen or carbon ions.

26. Use of a photodiode according to claim 1 in a EUV-lithographic tool.

27. Use of a photodiode according to claim 1 in a system for x-ray microscopy.

28. Use of a photodiode according to claim 1 in a system for x-ray fluorescence.

29. Use of a photodiode according to claim 1 in a system for spectroscopy.
